(19) United States
(12) Patent Application Publication
(10) Pub. No.: US 2012/0173855 A1
(43) Pub. Date: Jul. 5, 2012

(54) Exception Transporting and Handling of Concurrent Exceptions

(75) Inventor: Wesley Holler, Austin, TX (US)

(73) Assignee: ZEBRA IMAGING, INC., Austin, TX (US)

(21) Appl. No.: 12/983,280

(22) Filed: Dec. 31, 2010

(51) Int. Cl. G06F 9/38

(52) U.S. Cl. 712/244; 712/E09.06

(57) ABSTRACT

Methods and systems for handling exceptions, including being provided with a catch list, the catch list being a flattened inheritance tree for exception types in ascending inheritance order, receiving an exception from a thread, searching the catch list in ascending inheritance order to find a matching exception type to received exception.

### A. BACKGROUND

The invention relates generally to the field of exception transporting and the handling of concurrent exceptions in multiple thread environments.

### B. SUMMARY

In one respect, disclosed is a method for handling exceptions, the method comprising being provided with a catch list, the catch list being a flattened inheritance tree for exception types in ascending inheritance order, receiving an exception from a thread, searching the catch list in ascending inheritance order to find a matching exception type to received exception.

In another respect, disclosed is a system for handling exceptions, the system comprising one or more processors, one or more memory units coupled to the one or more processors, the system being configured to be provided with a catch list, the catch list being a flattened inheritance tree for exception types in ascending inheritance order, receive an exception from a thread, search the catch list in ascending inheritance order to find a matching exception type to received exception.

In yet another respect, disclosed is a computer program product embodied in a computer-operable medium, the computer program product comprising logic instructions, the logic instructions being effective to be provided with a catch list, the catch list being a flattened inheritance tree for exception types in ascending inheritance order, receive an exception from a thread, search the catch list in ascending inheritance order to find a matching exception type to received exception.

Numerous additional embodiments are also possible.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system for transporting exceptions between threads, in accordance with some embodiments.

FIG. 2 is a block diagram illustrating a system for transporting exceptions between threads using an exception queue, in accordance with some embodiments.

FIG. 3 is diagram illustrating an inheritance tree for exception types and the corresponding flattened catch list, in accordance with some embodiments.

FIG. 4 is a flow diagram illustrating a method for identifying the most derived exception type for a received exception, in accordance with some embodiments.

FIG. 5 is a flow diagram illustrating a method for transporting exceptions between threads, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for handling exceptions thrown by processes executing in different threads are disclosed. In some embodiments, errors in executed processes need to be handled properly, potentially in order to prevent the leaking of resources and/or the corruption of data. In some embodiments, systems and methods are disclosed for transporting exceptions occurring at one thread to another thread. Exceptions may be transported between threads for various reasons. For example, an exception may be thrown by a child process running in a second thread. In order to properly handle the exception, the exception may be transported to a first thread where the parent process is executing. The exception may be then handled properly at the first thread. If an exception is neither handled in a child thread nor is it transported, it would result in the unexpected termination of the application.

In some embodiments, the exception handling may occur at a main thread for exceptions thrown at all other sub-threads in the environment. Exceptions that may be thrown at other sub-threads may be transported to the main thread for handling.

In some embodiments, an exception queue may be implemented in order to handle multiple concurrent exceptions thrown in multiple threads. In some embodiments, exceptions (or pointers to or other information about the exceptions) may be stored in the exception queue and then handled in a first-in-first-out (FIFO) order.

It should be noted that concurrent exceptions, in some embodiments, indicate exceptions that have been thrown but are yet to be handled.

In some embodiments, the process handling the exceptions may handle an exception synchronously or may re-raise the exception. Synchronous exception processing allows the program to remain in its current frame of reference (as no frames are taken off of the stack) and easily resume a “main loop” while the re-throwing of an exception conforms to the more familiar stack unwinding model, as if the original exception throw had occurred in the main thread, allowing handlers to be shared for all threads, including the main thread. In some embodiments, the exception queue may be implemented as a class that provides a thread-safe container for pointers to the exceptions.

In some embodiments, catch lists (typelists) may be used to implement various types of functionality. Catch lists, which are compile-time data structures with, in some embodiments, no meaning at runtime, may be used to perform compile-time computations and to generate complex data types and routines. For example, a generic typelist implementation (recursive) may be used to represent the notion of a catch list, a list of types where various types may be thrown as exceptions. The list may be sorted from most-derived-type to least-derived-type in order for the compiler to pick the first exception type that may be converted to by the current exception.

In some embodiments, a compile-time recursive typelist parsing routine may be used to generate a runtime routine to determine which type in a catch list is the most-derived-type that is also a polymorphic identity of the current exception type. This method may be used in both the implementation of re-thrown exceptions and the exception copying code that is generated for each extended thread template instantiation. At runtime, the generated routines utilize runtime type information (RTTI) to identify an actual exception instance. Exception types in a given catch list, in some embodiments, may share a common ultimate parent class. In some embodiments, exception types may provide non-throwing copy constructors. In some embodiments, a catch list of the exception types may be formed by flattening an inheritance tree for exception types.

In some embodiments, the properties of the typelists may be used to enhance the usage of the exception handling scheme. For example, since typelists may be concatenated, multiple catch lists may be concatenated at compile time to produce a master catch list that is handled by a single exception queue at a single point in the main thread, resulting in cleaner handling code.

In an embodiment where C++ (or other similar programming language) may be used, the implementation of exception handling may comprise any of these components:
An exception pointer class that defines a type that may be used to transport exceptions between threads. The class may provide a template constructor for factor-creating exception pointers via a copy exception function and comparison operators for null pointer checking.
A copy exception template function configured to copy a current exception to a valid exception pointer instance.
A rethrow exception class template that acts as a surrogate for the rethrow exception function (with required compiler support). Template specializations of this class may be used to recursively construct a rethrow routine for a given catch list using RTTI.
An exception queue class template that is a thread-safe FIFO container for processing exception pointer instances.
An extended thread class that provides a mechanism for automatically transporting unhandled exceptions by copying the most-derived-type to an exception pointer.

In some embodiments, an extended thread may be implemented. The extended thread may be configured to automatically catch and transport unhandled exceptions and may be implemented as a class template that utilizes a catch list specification in order to determine which exception type is the most specific and can be matched against the most exception to be copied. [to be supplemented with]

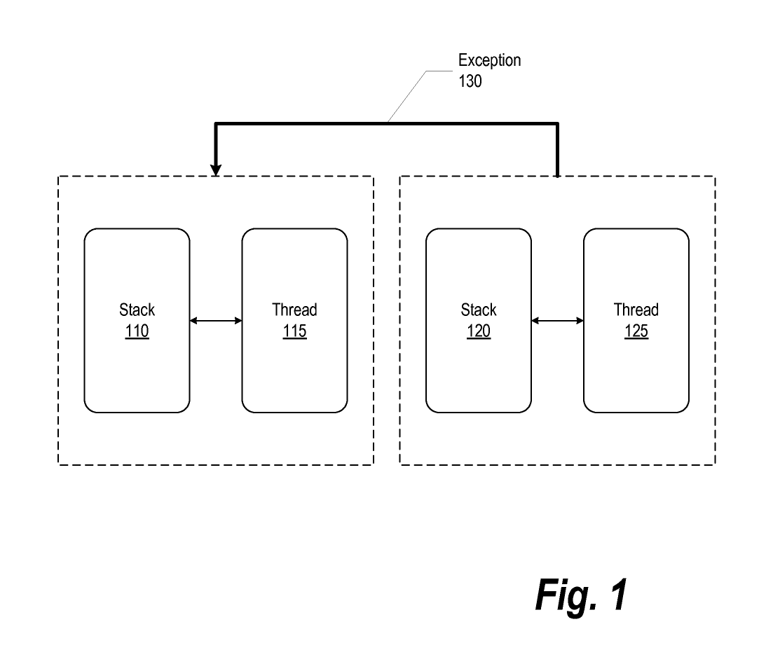

FIG. 1 is a block diagram illustrating a system for transporting exceptions between threads, in accordance with some embodiments.

In some embodiments, thread 115 is configured to execute processes stored in stack 110, and thread 125 is configured to execute processes stored in stack 120. In some embodiments, thread 115 and thread 125 may be part of a multi-threaded processor environment.

In some embodiments, the system may be configured to transport an exception that occurs in thread 125 to thread 115 in order for the exception to be handled by one or more processes executing at thread 125. In some embodiments, it may be advantageous to handle exceptions at thread 115. For example, the exception may have been thrown by a process executing at thread 125 that is a child process of a process executing at thread 115.

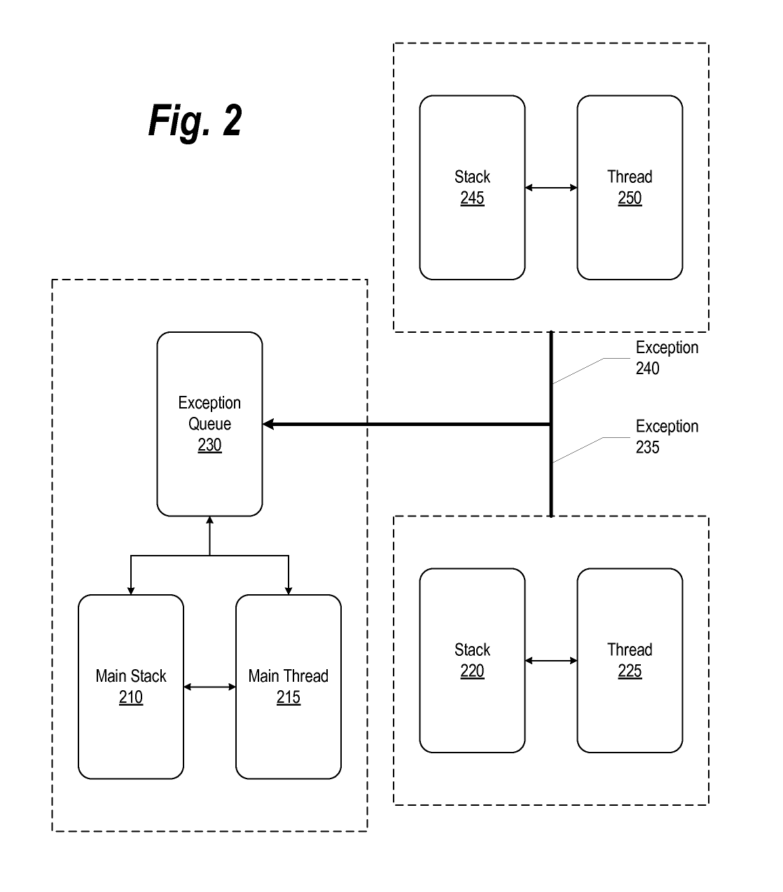

FIG. 2 is a block diagram illustrating a system for transporting exceptions between threads using an exception queue, in accordance with some embodiments.

In some embodiments, main thread 215 is configured to execute processes stored in main stack 210. Similarly, thread 225 is configured to execute processes stored in stack 220, and thread 250 is configured to execute processes stored in stack 245. In some embodiments, thread 215, thread 225, and thread 250 may be part of a multi-threaded processor environment.

Exception queue 230 is configured to store exceptions occurring in processes executing in multiple threads, such as thread 225 and thread 250. In some embodiments, the exceptions may be handled more properly by one or more processes executing at main thread 215. In some embodiments, the exceptions may be stored in and retrieved from exception queue 230 in first-in-first-out (FIFO) order.

Exception 240 is an example of an exception that may be thrown by a process executing in thread 250 and then transported and stored in exception queue 230 for handling. Exception 235 is an example of an exception that may be thrown by a process executing in thread 225 and then transported and stored in exception queue 230 for handling.

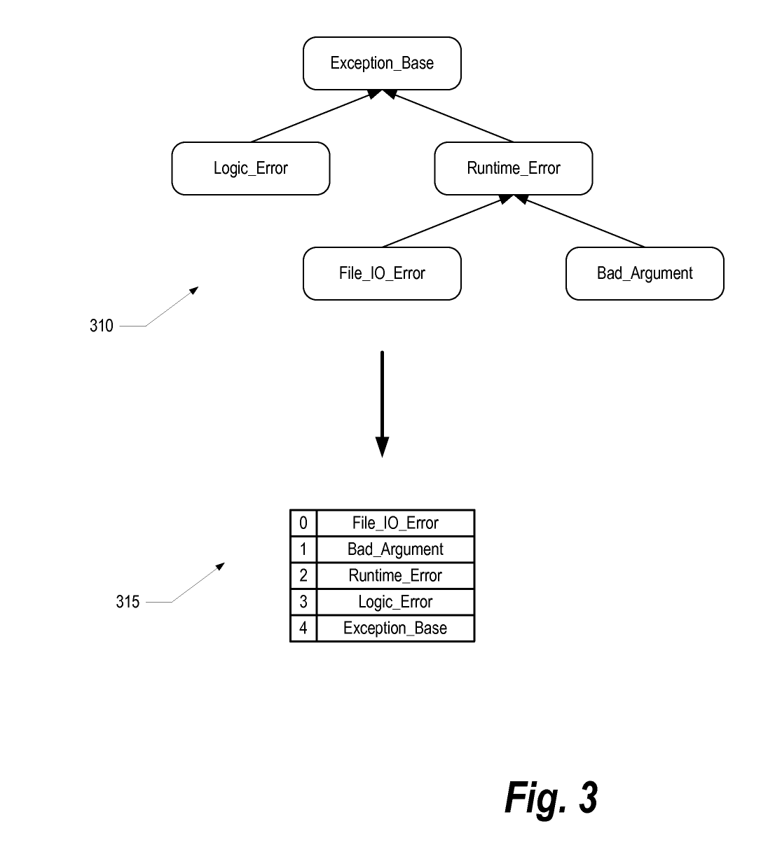

FIG. 3 is diagram illustrating an inheritance tree for exception types and the corresponding flattened catch list, in accordance with some embodiments.

Inheritance tree 310 is an example of an inheritance tree for exception types, the types that may be used to characterize exceptions that may be thrown in the system. In the example, the least derived type for the exception types is exception_base, which is a type that, in some embodiments, all exceptions belong to. Under exception_base, logic_error and runtime_error exist, and under runtime_error, file_io_error and bad_argument exist.

Flattened catch list 315 is an example of a flattened catch list derived from an inheritance tree. In this example, flattened catch list 315 is derived from inheritance tree 310. The most derived types, such as file_io_error and bad_argument, are placed at the top list. The next most derived types, such as logic_error and runtime_error, are placed on the list next, and finally, the least derived type, exception_base, is placed on the list last.

In some embodiments, flattened catch list 315 may be used at a thread receiving an exception in order to determine the most derived type that the received exception belongs to.

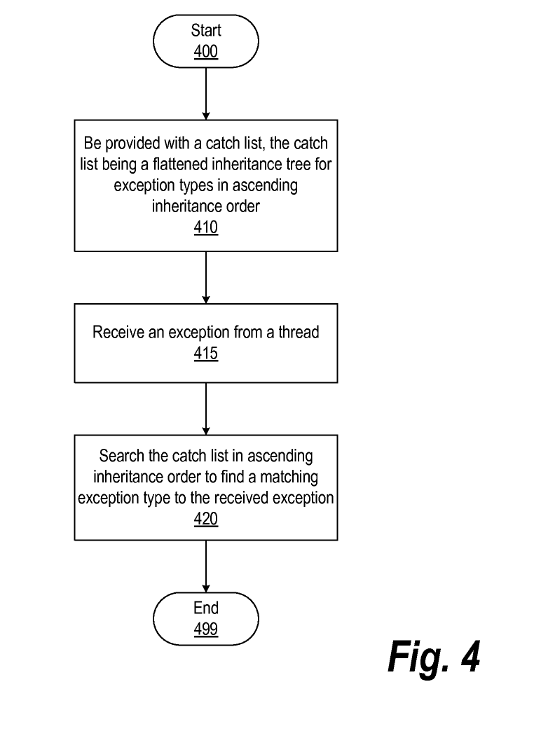

FIG. 4 is a flow diagram illustrating a method for identifying the most derived exception type for a received exception, in accordance with some embodiments.

In some embodiments, the method illustrated in this figure may be performed by one or more of the systems illustrated in FIG. 1 and FIG. 2.

At block 410, a catch list is provided, the catch list being a flattened inheritance tree for exception types in ascending inheritance order.

At block 415, an exception is received from another thread, and at block 420, the catch list is searched in ascending inheritance order to find a matching exception type to the received exception.

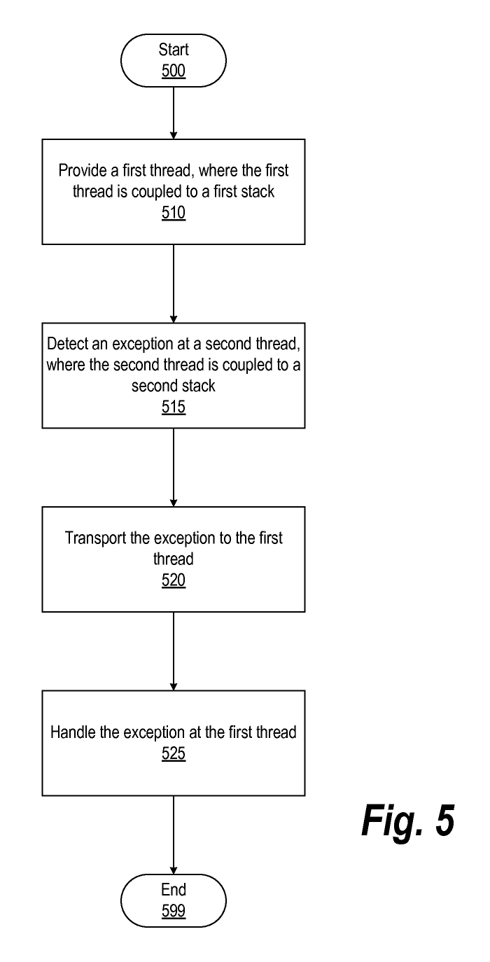

FIG. 5 is a flow diagram illustrating a method for transporting exceptions between threads, in accordance with some embodiments.

In some embodiments, the method illustrated in this figure may be performed by one or more of the systems illustrated in FIG. 1 and FIG. 2.

Processing begins at 500 whereupon, at block 510, a first thread is provided, where the first thread is coupled to a first stack.

At block 515, an exception is detected at a second thread, where the second thread is coupled to a second stack.

At block 520, the exception is transported to the first thread.

At block 525, the exception is handled at the first thread.

Processing subsequently ends at 599.
Examples of C++ code that may be used in various implementations of the systems and methods described here
   Example of transporting code

catch(SomeType& e)

{

global_eptr = Copy_Exception(e);

}
catch(SomeSuperType& e)
{

global_eptr = Copy_Exception(e);

}
...
...
...
catch(std::exception& e)
{

global_eptr = Copy_Exception(e);

}

i. Mechanism for generating the routines that copy or rethrow the most derived type that also identifies the current exception type

template <class CATCH_LIST> class Copy_Most_Derived;
template <typename HEAD, typename TAIL>
class Copy_Most_Derived <Typelist <HEAD, TAIL> >:

public Copy_Most_Derived <TAIL>

{
public:

void static copy(const std::exception& e, ExceptionTransportQueue&
eptrQueue)
{

if(const HEAD* pFound = dynamic_cast <const HEAD*>
(&e))
{

eptrQueue.pushException( Copy_Exception (*pFound) );

}
else
{

Copy_Most_Derived <TAIL>::copy(e, eptrQueue);

}

}

};
template <typename HEAD>
class Copy_Most_Derived <Typelist <HEAD, Null_Typelist> >
{
public:

void static copy(const std::exception& e, ExceptionTransportQueue&
eptrQueue)
{

if(const HEAD* pFound = dynamic_cast <const HEAD*>
(&e))
{

eptrQueue.pushException( Copy_Exception (*pFound) );

}
else
{

assert(true);

}

}

};

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for handling exceptions, the method comprising:
being provided with a catch list, the catch list being a flattened inheritance tree for exception types in ascending inheritance order;
receiving an exception from a thread;
searching the catch list in ascending inheritance order to find a matching exception type to the received exception.

2. The method of claim 1, further comprising handling the exception according to the matched exception type.

3. The method of claim 1, where searching the catch list comprises recursively searching the catch list.

4. The method of claim 1, further comprising:
throwing the exception at the thread;
at the thread, searching the catch list in ascending inheritance order to find a matching exception type to the exception;
copying information about the exception at a memory location;
creating a pointer to the memory location; and
transporting the information via the pointer to the exception.

5. The method of claim 4, where receiving the exception from the thread comprises receiving the pointer to the exception.

6. The method of claim 1, further comprising
receiving the exception at an exception queue, the exception being configured to store and release transported exceptions in a FIFO order;
retrieving the exception from the exception queue in the FIFO order.

7. A system for handling exceptions, the system comprising:
one or more processors;
one or more memory units coupled to the one or more processors;
the system being configured to:
be provided with a catch list, the catch list being a flattened inheritance tree for exception types in ascending inheritance order;
receive an exception from a thread;
search the catch list in ascending inheritance order to find a matching exception type to the received exception.

8. The system of claim 7, further comprising the system being configured to handle the exception according to the matched exception type.

9. The system of claim 7, where the system being configured to search the catch list comprises the system being configured to recursively search the catch list.

10. The system of claim 7, where the system is further configured to:
throw the exception at the thread;
at the thread, search the catch list in ascending inheritance order to find a matching exception type to the exception;
copy information about the exception at a memory location;
create a pointer to the memory location; and
transport the information via the pointer to the exception.

11. The system of claim 10, where the system being configured to receive the exception from the thread comprises the system being configured to receive the pointer to the exception.

12. The system of claim 7, where the system is further configured to:
receive the exception at an exception queue, the exception being configured to store and release transported exceptions in a FIFO order;
retrieve the exception from the exception queue in the FIFO order.

13. A computer program product embodied in a computer-operable medium, the computer program product comprising logic instructions, the logic instructions being effective to:
be provided with a catch list, the catch list being a flattened inheritance tree for exception types in ascending inheritance order;
receive an exception from a thread;
search the catch list in ascending inheritance order to find a matching exception type to the received exception.

14. The product of claim 13, further comprising the logic instructions being effective to handle the exception according to the matched exception type.

15. The product of claim 13, where the logic instructions being effective to search the catch list comprises the logic instructions being effective to recursively search the catch list.

16. The product of claim 13, where the logic instructions are further effective to:
throw the exception at the thread;
at the thread, search the catch list in ascending inheritance order to find a matching exception type to the exception;
copy information about the exception at a memory location;
create a pointer to the memory location; and
transport the information via the pointer to the exception.

17. The product of claim 16, where the logic instructions being effective to receive the exception from the thread comprises the logic instructions being effective to receive the pointer to the exception.

18. The product of claim 13, where the logic instructions are further effective to:
receive the exception at an exception queue, the exception being effective to store and release transported exceptions in a FIFO order;
retrieve the exception from the exception queue in the FIFO order.
